(19) United States
(12) Patent Application Publication
(10) Pub. No.: US 2016/0039113 A1
(43) Pub. Date: Feb. 11, 2016

(54) PROCESSES FOR THE DENSIFICATION OF A CELLULOSIC SUBSTRATE

(71) Applicant: ARMSTRONG WORLD INDUSTRIES, INC., Lancaster, PA (US)

(72) Inventors: STEVEN BUKOWSKI, East Petersburg, PA (US); SUNIL RAMACHANDRA, Lancaster, PA (US); BRIAN BEAKLER, YORK, PA (US)

(21) Appl. No.: 14/780,209

(22) PCT Filed: Mar. 28, 2014
(86) PCT No.: PCT/US2014/032178

§ 371 Date: Sep. 25, 2015

Related U.S. Application Data
(60) Provisional application No. 61/806,704, filed on Mar. 29, 2013.

(51) Int. Cl. B27K 5/06; E04F 15/04; E04F 15/02; B27N 3/08; B27K 5/00

(52) U.S. Cl. CPC B27K 5/065; B27N 3/08; B27K 5/007; B27K 5/0085; E04F 15/02038; E04F 15/041

(57) ABSTRACT

A process for the densification of a cellulosic substrate, the process comprising: providing an apparatus comprising: a top calendar roll; a bottom calendar roll; and an in-feed conveyor; wherein the distance between the top calendar roll and the bottom calendar roll defines a separation gap; providing a cellulosic substrate having a thickness greater than the separation gap; and feeding the cellulosic substrate through the separation gap between the top calendar roll and the bottom calendar roll.

### CROSS-REFERENCE TO RELATED PATENT APPLICATION

This application claims the benefit of priority to U.S. Provisional Application Ser. No. 61/806,704, filed Mar. 29, 2013, the contents of which are hereby incorporated herein in their entirety.

### FIELD OF THE DISCLOSURE

The present invention is directed to process for the densification of a cellulosic substrate. More specifically, the present invention is directed to a process for densification of a cellulosic substrate for us in a flooring system.

### BACKGROUND

Wood flooring endures seasonal expansion and contraction when exposed to variations in equilibrium moisture content (EMC). When EMC levels plummet, boards shrink creating spaces between the wood flooring boards. During periods of both elevated EMC and depressed EMC, installed wood flooring boards swell creating cupping (moisture adsorption from the bottom of the product), a condition in which the edges of the board are high and the center is low; or crowning (moisture adsorption from the top or face of the product), the opposite of cupping, where the middle of the board is higher than the edges of the board. The tendency of wood flooring to exhibit cupping or crowning in humid conditions and dry conditions is a limitation for the use of wood flooring in below grade installations and low EMC installations and further exacerbated when wider width wood flooring, for example, when products greater than 3.25 inches wide, are installed.

Engineered wood flooring is a multiple-layered structure having a top layer of decorative wood veneer bonded to multiple core or base layers of a manufactured wood product, for example, fiberboard and veneer core plywood. Engineered wood floors have a greater resistance to dimensional change in elevated EMC conditions than solid wood flooring and appeal to use below grade and in regions of high EMC. In the case of dry EMC conditions, however, dimensional changes in engineered wood flooring lead to in-service issues. Engineered wood flooring made with rotary-peeled face veneers tends to exhibit veneer checking or lathe checks, a condition that creates micro cracks in the decorative wood veneer layer of the product.

Flooring materials are subjected to impacts from objects that may be inadvertently dropped onto surfaces and potentially creating a permanent depression or dent in the flooring surface. Indent resistance of wood flooring products is influenced by the specific gravity of the wood-type used to make the flooring product. Additionally, indent resistance is increased beyond that of the wood-type of the face veneer by use of chemical impregnation. However, in addition to the added cost, traditional impregnation chemicals may impinge on potential environmentally friendly (green) positioning of wood flooring products.

In the normal service of wood flooring products, especially solid wood and wood veneers, fading or change in color occurs when wood flooring products are exposed to ultraviolet light, such as sunlight through a window. Remediation steps to restore the initial color of the wood flooring include sanding, stripping, and refinishing or board replacement.

A wood flooring product that is dimensionally stable to variations in EMC, resists veneer checks, indent resistant, and resists fading from exposure to sun light would be desirable in the art.

### SUMMARY

Some embodiments provide a process for the densification of a cellulosic substrate, the process comprising: providing an apparatus comprising: a top calendar roll; a bottom calendar roll; a heat source; and an in-feed conveyor; wherein the distance between the top calendar roll and the bottom calendar roll defines a separation gap; providing a cellulosic substrate having a thickness greater than the separation gap; and feeding the cellulosic substrate through the separation gap between the top calendar roll and the bottom calendar roll.

Other embodiments provide a process for the densification of wood wherein a cellulosic substrate or veneer is heated to a temperature of about 230° F. (110° C.), or below the glass transition point of the lignocellulosic polymers in the substrate, compressing the heated substrate and cooling the compressed substrate to ambient conditions.

In an exemplary embodiment, a process for the densification of wood is disclosed wherein a wood or veneer is heated to a temperature between about 230° F. (110° C.) and 340° F. (171° C.), or below the glass transition point of the lignocellulosic polymers in the wood. The heated wood is compressed by a rotary press or calendar. After exiting the calendar and while no longer under compression, the densified wood is air cooled to ambient conditions.

In another exemplary embodiment, a densified wood product is disclosed where the pre-compressed wood such as, but not limited to, untreated, uncompressed veneer is compressed from about ten to about seventy-five percent, between about ten percent and about twenty percent, between twenty percent and about thirty percent, between about twenty-five percent and about fifty percent, between about thirty percent and about sixty percent, between about fifty percent and about seventy-five percent, about ten percent, about twenty percent, about twenty-five percent, about forty percent, about fifty percent, about sixty percent, about seventy-five percent, or any combination or sub combination therein, of the pre-compressed thickness of the wood.

Other features and advantages of the present invention will be apparent from the following more detailed description of the preferred embodiment.

### DETAILED DESCRIPTION

As used herein, the terms “thermally compressed” or “thermal compression” refer to products or processes that use—inter alia—heat and mechanical compression to densify a substrate. Exemplary thermal compression techniques are described in U.S. Pat. No. 7,404,422 to Kamke et al., the contents of which are hereby incorporated herein in their entirety.

Embodiments of the present disclosure permit the manufacture of densified wood products and materials that are indent resistant, dimensionally stable from variations in equilibrium moisture content, and resistant to fading. Products are further processed by cutting and shaping to include flooring and underlayment materials, trim, and furniture manufacture.

In some embodiments, the present invention provides a A process for the densification of a cellulosic substrate, the process comprising: providing an apparatus comprising: a top calendar roll; a bottom calendar roll; a heat source; and an in-feed conveyor; wherein the distance between the top calendar roll and the bottom calendar roll defines a separation gap; providing a cellulosic substrate having a thickness greater than the separation gap; and feeding the cellulosic substrate through the separation gap between the top calendar roll and the bottom calendar roll.

In some embodiments, the process further comprises the step of heating the cellulosic substrate to its glass transition temperature prior to feeding it through the separation gap. In some embodiments, the heat source comprises a heated calendar roll, an infrared (IR) lamp, a microwave oven, a convection oven, or a combination thereof. In some embodiments, the heat source comprises an IR lamp and the IR lamp is contained within an IR chamber.

In some embodiments, the cellulosic substrate comprises a cellulosic material derived from a soft wood or a tropical wood. In some embodiments, the first thermally compressed cellulosic substrate comprises a cellulosic material derived from Caribbean walnut, coffee bean, natural bamboo, Australian cypress, white oak, Tasmanian oak, ribbon gum, ash, American beech, red oak, Caribbean heart pine, yellow birch, Movingui, heart pine, Carapa Guianensis, larch, carbonized bamboo, teak, cocobolo, rose gum, Makore, Siberian larch, Peruvian walnut, Boreal, black walnut, cherry, red maple, boire, paper birch, eastern red cedar, southern yellow pine, lacewood, African mahogany, Honduran mahogany, Parana, sycamore, Shedua, silver maple, Douglas fir, juniper, chestnut, hemlock, western white pine, basswood, eastern white pine, balsa, cuipo or a combination of two or more thereof.

In some embodiments, the cellulosic substrate comprises a cellulosic material derived from eastern white pine, hemlock, catalpa, alder, cypress, Douglas fir, hackberry, cherry or a combination thereof.

In some embodiments, the cellulosic substrate is fed through the separation gap at a line speed of from about 5 ft./min to about 10 ft./min. In some embodiments, the top calendar roll is heated to a temperature of from about 110° C. to about 120° C. In some embodiments, the bottom calendar roll is heated to a temperature of from about 150° C. to 235° C.

In some embodiments, the top calendar roll and bottom calendar roll rotate in opposite directions.

Some embodiments further comprise the step of moisturizing the cellulosic substrate. In some embodiments, the step of moisturizing the cellulosic substrate comprises soaking the cellulosic substrate in an aqueous medium.

In some embodiments, the cellulosic substrate has a thickness of from about 1 mm to about 2.5 mm.

Some embodiments further comprise the step of cooling the cellulosic substrate.

In some embodiments, the cellulosic substrate is compressed to from about 10% to about 30% of its original thickness.

Other embodiments provide a hybrid flooring product comprising: a face layer comprising a densified cellulosic substrate produced by the process of any one of claims 1 to 13; and a core comprising a material selected from fiberboard; cement; a vinyl composite, a wood-plastic composite; rubber; and a combination thereof.

In some embodiments, the hybrid flooring product further comprises a locking profile. In some embodiments, the locking profile is selected from tongue and groove; lock and fold; ship-lap; angle-angle; and click-lock. In some embodiments, the locking profile is selected from tongue and groove and lock and fold. In some embodiments, the second layer comprises the locking profile. Suitable locking profiles are described, for example, in U.S. Pat. No. 8,544,234 to Pervan et al. or U.S. Pat. No. 6,874,292 to Moriau et al., the contents of which are hereby incorporated herein in their entireties.

According to the American National Standards Institute, a veneer is a thin sheet of wood, rotary cut, sliced, or sawed from a log, bolt, or flitch. The formation of densified wood and densified veneer products would permit the manufacture of, for example, wood flooring having densified wood or veneer in the core construction or as a decorative layer.

A commonly occurring and costly problem in wood manufacturing is the development of small cracks or micro cracks in the wood finish called lathe checks or veneer checks. Veneer checks usually appear as uniformly spaced hairline cracks in the finish, or in severe cases, cracks with accompanying ridges on the wood surface which actually can be detected by touch. Veneer checks are typically formed when tensile stress failures occur in the face veneer, caused by differential shrinkage or swelling between the face veneer and the panel substrate to which it is applied. As the EMC of the environment changes, so does the moisture content of the wood panel. Changes in moisture content of the wood panel affect shrinkage and swelling of the wood panel. When a veneered panel shrinks or swells, the veneer may not expand or contract at the same rate as the substrate due to the material orientation or construction. This can create considerable stresses within the panel which, if great enough, result in wood failure. Such failures in the face veneer then create tensile stress concentrations in the finish which result in the visible cracks or veneer checks. In one embodiment, veneer checks formed from the veneer process were compressed and closed after densifying the wood veneer, and therefore, engineered wood flooring made with densified rotary-peeled face veneers are suitable for installations having dry environmental conditions.

In one embodiment, the wood flooring product includes multiple layers. Although two layers are detailed herein, the wood flooring product includes about three layers, about four layers, about five layers, about six layers, about seven layers, about eight layers, about nine layers, about ten layers, about eleven layers, or additional layers as warranted by the product construction. In one embodiment, a densified wood or veneer is positioned as a top or decorative layer in a multi-layer wood flooring product. In another embodiment, the densifled wood or veneer forms the base of a layered wood flooring product. In yet another embodiment, the densified wood is positioned throughout a layered wood flooring product to improve the dimensional stability of the layered wood flooring product.

In one embodiment, the top layer, also referred to as a first layer or decorative layer includes a densified veneer. The top layer is bonded to one or more layers by epoxy, urethane, acrylate, acetate, phenol formaldehyde, urea formaldehyde, ioscyanate, soy, starch, or protein based, other biobased adhesives, or any other bonding agent as known in the arts. In one embodiment, the base layer is solid wood such as a hard wood, a soft wood, or a porous material such as cork.

In one embodiment, the densifled top layer is bonded to one or more layers where the base layer is a manufactured cellulosic product, for example medium density fiberboard, high density fiberboard, plywood, oriented strand board, chipboard, felt, or any other suitable product. In one embodiment, the densifled top layer is bonded to one or more layers where the base layer is cement, concrete, or composites thereof In yet another embodiment, the base layer contains a polymeric binder, for example, but not limited to, extruded wood products, filled polymeric compositions, urethane foams, or any other suitable material. In one embodiment, the polymeric binder of the base layer is an acrylated, epoxidized, or esterified biobased polymer such that the polymer components are derived from natural, renewable sources as opposed to petroleum products. Additionally or alternatively, filled polymeric compositions have fillers obtained from natural, renewable sources, such as, for example, aragonite. Additionally, the base layer could be a rubber based, elastomeric based material or a wood plastic composite type material which is a combination of cellulosic with polymeric or filled polymeric or elastomeric material.

Densified wood is prepared by several methods, for example, by injecting a resin, such as phenol, into the wood to strengthen the wood by the curing of the resin. Wood may also be densified by a combination of injecting resins and compressing the wood. Other methods include a process whereby the wood is subjected to an elevated temperature and moisture, compressing the wood component perpendicular to the grain, and annealing the wood, usually while under pressure, to ambient conditions.

In one embodiment, wood veneer is heated in the range of about 230° F. (110° C.) to about 480° F. (249° C.), from about 230° F. (110° C.) to about 250° F. (121° C.), from about 250° F. (121° C.) to about 300° F. (149° C.), from about 300° F. (149° C.) to about 350° F. (177° C.), from about 350° F. (177° C.) to about 400° F. (204° C.), from about 400° F. (204° C.) to about 450° F. (232° C.), from about 450° F. (232° C.) to about 480° F. (249° C.), at about 230° F. (110° C.), at about 250° F. (120° C.), at about 300° F. (149° C.), at about 350° F. (177° C.), at about 400° F. (204° C.), at about 450,° F. (232° C.), at about 480° F. (249° C.), or any combination or sub combination by convection, infrared, microwave, or a combination thereof. Convection heating includes a heat source, forced air, or non turbulent air. Infrared heating includes subjecting an article to electromagnetic radiation from about 280 nm to above 3,000 nm, in the range of about 280 nm to about 1400 nm, of about 1400 nm to about 3,000 nm, above 3,000 nm, or any combination, or sub-combination therein. Microwave heating includes subjecting an article to electromagnetic radiation.

In one embodiment, wood veneer is heated up to the glass transition point of the lignocellulosic polymers in the wood veneer. The glass transition point is the temperature at which the elements that provide wood with its rigid characteristics, precisely lose the character of rigidity, so the material passes from a rigid state to a rubbery state. In one embodiment, the glass transition point corresponds to about 410° F. (210° C.).

In one embodiment, wood veneer is heated to below the glass transition point of the lignocellulosic polymers in the wood, the temperature below the glass transition point of the lignocellulosic polymers in the wood is maintained before and during compression of the wood veneer. Further, the wood veneer is compressed while maintaining the temperature of the wood veneer to below the glass transition point, whereby the wood will densify without breaking or crushing the wood cellular structure. As such, the wood cells should compress with little or no fracture. Maintaining the temperature of below the glass transition point of the lignocellulosic polymers in the wood, prior to and during compression, will densify the wood veneer without breaking or crushing the wood cellular structure, therefore the mechanical properties of the wood veneer are not diminished. In another embodiment, wood veneer heated to below the glass transition point exhibits a distinct deepening in color without surface char.

In one embodiment, a rotary press or calendar, progressively compresses a wood or wood veneer from its pre-compression thickness to a reduced, or compressed thickness. A calendar consists of two or more metal drums or rolls, where a first roll engages with a second roll, and the face of the first roll is parallel to the face of the second roll. The rolls rotate in opposite directions, having a separation distance less than the original thickness of the article being compressed, for example, a wood veneer. Additionally, the calendar rolls have a surface covering, such as a smooth or textured surface, chrome plating, rubber facing, or felt facing. The textured surface also includes a rough surface, knurling, cogs, or a pattern for embossing. Alternatively, the calendar rolls are heated, cooled, or a combination thereof. In one embodiment, the calendar rolls are heated by steam or hot oil.

In one embodiment, calendar rolls are heated to less than the glass transition point of wood, for example, in the range of about 230° F. (110° C.) to about 480° F. (249° C.), from about 230° F. (110° C.) to about 250° F. (120° C.), from about 250° F. (121° C.) to about 300° F. (149° C.), from about 300° F. (149° C.) to about 350° F. , (177° C.) from about 350° F. (177° C.) to about 400° F. (204° C.), from about 400° F. (204° C.) to about 450° F. (232° C.), from about 450° F. (232° C.) to about 480° F. (249° C.), at about 230° F. (110° C.), at about 250° F. (120° C.), at about 300° F. (149° C.), at about 350° F. (177° C.), at about 400° F. (204° C.), at about 450,° F. (232° C.), at about 480° F. (249° C.), or any combination or sub combination thereof. Additionally or alternatively, calendar rolls are heated to the same temperature or one calendar roll has a different temperature with respect to the other calendar roll. For example, the top calendar roll is heated in the range of about 230° F. (110° C.) to about 242° F. (167° C.) and the bottom calendar roll is heated in the range of about 329° F. (165° C.) to about 340° F. (171° C.). While the embodiment is not limited to the top calendar roll having the lower temperature as the embodiment will function with the top calendar roll having the higher temperature and the bottom calendar roll having the lower temperature. In another embodiment, one or both calendar rolls are at ambient temperature.

In one embodiment, the wood is compressed between two calendar rolls. The time during which the wood is under compression is from about 0.02 to about 3.0 seconds, from about 0.02 to about 0.05 seconds, from about 0.05 to about 0.10 seconds, from about 0.10 to about 0.50 seconds, from about 0.50 to about 1.0 seconds, from about 1.5 to about 2.0 seconds, from about 2.5 to about 3.0 seconds, at about 0.02 seconds, at about 0.05 seconds, at about 1.0 seconds, at about 1.5 seconds, at about 2.0 seconds, at about 2.5 seconds, at about 3.0 seconds, or any combination or sub combination of time therein.

After the compressed wood exits the calendar rolls and is no longer under compression, the compressed wood is cooled. In one embodiment, the heated, compressed, densified wood, is air cooled by chilled air, ambient air, forced, or non turbulent air.

In one embodiment, oak and maple wood veneers of 0.083 inches (2.11 mm) thick are heated to below the glass transition point of the wood then compressed while maintaining the temperature below the glass transition point of the wood. In one embodiment, the oak wood veneer was compressed from a pre-compressed thickness of 0.083 inches (2.11 mm) to a compressed thickness of 0.045 inches (1.14 mm), or about forty-five percent compression. In another embodiment, the maple veneer was compressed from a pre-compressed thickness of 0.083 (2.11 mm) to a compressed thickness of 0.031 inches (0.787 mm) thick, or a compression of about sixty-three percent. Additional samples of oak and maple wood veneers of 0.083 inch (2.11 mm) thickness were compressed without heating and at ambient temperature.

In one embodiment, the densification of wood increased the density to about 1.30 times the initial density of the wood. In another embodiment, the densified wood product having a densified veneer is obtained from species of hard wood, soft wood, or tropical wood.

The manufacture of wood flooring products is known in the arts. In one embodiment, a densified wood product having a densified veneer is fashioned into planks, having an edge perpendicular to the face and any combination of thickness, width, and length as required. In another embodiment, the densified wood product having a densified veneer is fashioned into planks, having any combination of thickness, width, and length as required and the elongated edges machined to include a tongue and grove feature. In yet another embodiment, the densified wood product having a densified veneer is fashioned into planks, having any combination of thickness, width and length as required and the elongated edges further machined to have locking tongue and grove features.

In one embodiment, a wood flooring product having dimensions of thickness, width and length vary to suit the application. Thickness varies from about 1/16inch (1.59 mm) to about 1 inch (2.54 mm), from about 1/16inch (1.59 mm) to about 1/4 inch (6.35 mm), from about 1/4 inch (6.35 mm) to about ⅜inch (9.53 mm), from about 5/16 inch (7.95 mm) to about 1/2 inch (12.7 mm), from about 5/8 inch (15.9 mm) to about 7/16 inch (11.1 mm), from 3/4 inch (19.1 mm) to about 1 inch (25.4 mm), or any size in between. Flooring width varies from about 2 inches (50.8 mm) to about 24 inches (609.6 mm)s, from about 2 inches (50.8 mm) to about 3-1/4 inches (82.6 mm), from about 3-1/4 inches (82.6 mm) to about 5 inches (50.8 mm), and from about 5 inches (127 mm) to about to 12 inches (305 mm), from about 12 inches (305 mm) to about 16 inches (406 mm), from about 12 inches (305 mm) to about 24 inches (610 mm), or any size in between. Lengths are, for example, but not limited to, about one-half foot (0.152 m) to about twelve feet (3.66 m), from about one-half foot (0.152 m) to about one foot (0.305 m), from about three feet (0.914 m) to about six feet (1.83 m), from about eight feet (2.44 m) to about ten feet (3.05 m), from about ten feet (3.05 m) to about twelve feet (3.66 m), from about one-half meter to about one meter, from about two meters to about three meters and from about three meters to about four meters, or any size in between. In one embodiment, the flooring is a square tile having equal dimensions of two adjacent sides from about 2 inches (5 cm) to about 24 inches (60 cm), from about 2 inches (5 cm) to about 2 inches (5 cm), from about 4 inches (10 cm) to about 4 inches (10 cm), from about 6 inches (15 cm) to about 6 inches (15 cm), from about 9 inches (20 cm) to about 9 inches (20 cm), from about 12 inches (30 cm) to about 12 inches (30 cm), from about 16 inches (40 cm) to about 16 inches (40 cm), from about 18 inches (45 cm) to about 18 inches (45 cm), from about 24 inches (60 cm) to about 24 inches (60 cm), or any size in between.

Wood flooring products are subjected to impacts from objects that may be inadvertently dropped onto flooring surfaces. It is not possible to know all of the factors related to the dropped objects (shape, weight, height of drop) or the condition of the environment in which the floor is located (types of subfloor, degree of adhesion to subfloor, temperature). Wood floor specimens having a densified first layer are evaluated for impact resistance using a ball drop test method which provides a relative measure of resistance to impact of wood flooring. In one embodiment, the wood flooring product having densified first layer has an indent resistance greater than untreated wood.

Width and thickness dimensions of wood flooring typically change when wood flooring is exposed to variations in EMC. When wood flooring is manufactured to appropriate moisture content, wood flooring maintains dimensional stability in the ambient relative humidity range between about 30 percent to about 50 percent. Humid conditions occur when the ambient relative humidity is above 50 percent, above 60 percent, above 70 percent, and above 80 percent. Conversely, dry conditions occur when the ambient relative humidity is less than 30 percent, less than 20 percent, and less than 10 percent. In moist conditions, moisture adsorption causes wood flooring boards to expand across the width of the boards. Conversely, in dry conditions, moisture desorption causes wood flooring boards to contract across the width of the boards. In both moist and dry conditions, the cumulative effects of expansion and contraction result in cupping and crowning across wood flooring boards. The potential to cup or crown is a limitation for use of wood flooring in below grade or other installations which typically have wet or moist conditions as well as dry conditions and is further exacerbated when wider width wood flooring, for example, greater than 3.25 inches (82.6 mm) wide is installed. In one embodiment, the densified wood product having a densified veneer has greater resistance to dimensional changes due to EMC changes than untreated wood. Additionally, the wood flooring product having a densified veneer is dimensionally stable as associated with wet and dry conditions, and therefore, is suitable for installations below grade or having moist conditions as well as dry conditions. In one embodiment, a wood flooring product having a densified veneer has a width greater than 3.25 inches (82.6 mm).

Wood flooring products, especially solid wood and veneer, fade or change shades over time. Exposure to sunlight greatly exacerbates this problem. Methods in the art to slow the fading process include treatments, for example, a surface treatment containing ultraviolet inhibitors that add additional cost to the manufactured product and further hinder refinishing techniques. In one embodiment, wood flooring products having a densified first layer without additional treatments have favorable light stability as compared to untreated wood.

The invention will be described in greater detail by way of specific examples. The following examples are offered for illustrative purposes and are not intended to limit the invention in any manner. Those skilled in the art will readily recognize a variety of noncritical parameters, which can be changed or modified to yield essentially the same results.

### EXAMPLES

### Example 1

Dynamic mechanical analyses (DMAs) of cellulosic substrates densified according to exemplary methods of the present invention and untreated cellulosic substrates are conducted. Results of the DMAs are used to calculate The Coefficient of Hygroscopic Expansion (CHE) for these substrates, using the following equation:

$$CHE = \frac{Δ L}{L Δ RH}$$

wherein
ΔL is the change in length of the sample
L is the original length of the sample; and
ΔRH is the change in % relative humidity.

Results of the CHE comparison demonstrate that cellulosic substrates densified according to exemplary methods of the present invention provide a lower CHE than untreated cellulosic substrates of similar composition. These results suggest that cellulosic substrates densified according to exemplary methods of the present invention would be expected to provide greater stability than untreated cellulosic substrates of similar composition.

TABLE 1

| | CHE |
|---|---|
| Oak | |
| Untreated | 0.000189 |
| Compressed w/o Heat | 0.000149 |
| Compressed w/Heat | 0.000144 |
| Maple | |
| Untreated | 0.000206 |
| Compressed w/o Heat | 0.000195 |
| Compressed w/Heat | 0.000167 |

It is intended that any patents, patent applications or printed publications, including books, mentioned in this patent document be hereby incorporated by reference in their entirety.

As those skilled in the art will appreciate, numerous changes and modifications may be made to the embodiments described herein, without departing from the spirit of the invention. It is intended that all such variations fall within the scope of the invention.

1. A process for the densification of a cellulosic substrate, the process comprising:
providing an apparatus comprising:
a top calendar roll;
a bottom calendar roll;
a heat source; and
an in-feed conveyor;
wherein the distance between the top calendar roll and the bottom calendar roll defines a separation gap;
providing a cellulosic substrate having a thickness greater than the separation gap; and
feeding the cellulosic substrate through the separation gap between the top calendar roll and the bottom calendar roll.

2. The process of claim 1, further comprising the step of heating the cellulosic substrate to its glass transition temperature prior to feeding it through the separation gap.

3. The process of claim 1, wherein the heat source comprises a heated calendar roll, an infrared (IR) lamp, a microwave oven, a convection oven, or a combination thereof.

4. The process of claim 3, wherein the heat source comprises an IR lamp and the IR lamp is contained within an IR chamber.

5. The process of claim 1, wherein cellulosic substrate is fed through the separation gap at a line speed of from about 5 ft./min to about 10 ft./min.

6. The process of claim 1, wherein the top calendar roll is heated to a temperature of from about 110° C. to about 120° C.

7. The process of claim 1, wherein the bottom calendar roll is heated to a temperature of from about 150° C. to 235° C.

8. The process of claim 1, wherein the top calendar roll and bottom calendar roll rotate in opposite directions.

9. The process of claim 1, further comprising the step of moisturizing the cellulosic substrate.

10. The process of claim 9, wherein the step of moisturizing the cellulosic substrate comprises soaking the cellulosic substrate in an aqueous medium.

11. The process of claim 1, wherein the cellulosic substrate has a thickness of from about 1 mm to about 2.5 mm.

12. The process of claim 1, further comprising the step of cooling the cellulosic substrate.

13. The process of claim 1, wherein the cellulosic substrate is compressed to from about 10% to about 30% of its original thickness.

14. A hybrid flooring product comprising:
a face layer comprising a densified cellulosic substrate produced by the process of claim 1; and
a core comprising a material selected from fiberboard; cement; a vinyl composite, a wood-plastic composite; rubber; and a combination thereof.

15. The product of claim 14, further comprising a locking profile.

16. The product of claim 15, wherein the locking profile is selected from tongue and groove; lock and fold; ship-lap; angle-angle; and click-lock.

17. The product of claim 16, wherein the locking profile is selected from tongue and groove and lock and fold.

18. The product of claim 15, wherein the second layer comprises the locking profile.
